(19) United States
(12) Patent Application Publication
(10) Pub. No.: US 2015/0293783 A1
(43) Pub. Date: Oct. 15, 2015

(54) SCHEDULING IDENTITY MANAGER RECONCILIATION TO EXECUTE AT AN OPTIMAL TIME

(71) Applicant: INTERNATIONAL BUSINESS MACHINES CORPORATION, Armonk, NY (US)

(72) Inventors: Christopher D. Brooks, Raleigh, NC (US); Quang T. Duong, Austin, TX (US); Nnaemeka I. Emejulu, Austin, TX (US); Anil K. Levi, Round Rock, TX (US); Karthikeyan Ramamoorthy, Austin, TX (US); Vincent C. Willimas, Mission Viejo, CA (US)

(73) Assignee: INTERNATIONAL BUSINESS MACHINES CORPORATION, Armonk, NY (US)

(21) Appl. No.: 14/248,540

(22) Filed: Apr. 9, 2014

(51) Int. Cl. G06F 9/48; G06F 9/50

(52) U.S. Cl. CPC G06F 9/4881; G06F 9/5077

(57) ABSTRACT

Provided are techniques for the scheduling of an identity Manager reconciliation at an optimal time. The techniques include partitioning a security identity management handling task into a First sub-task and a second sub-task; assigning to the first sub-task a first priority, based upon a first projected number of accounts affected by the first sub-task, a first attribute criteria, a first expected completion time, and a corresponding first scheduler index value, based upon the first priority; and assigning to the second sub-task a second priority, based upon a second projected number of accounts affected by the second sub-task, a second attribute criteria, a second expected completion time, and a second scheduler index value, based upon the second priority; and scheduling the first sub-task prior to the second sub-task in accordance with a prioritization algorithm in which a first weighted combination of the first priority and first expected completion time is greater than a second weighted combination of the second priority and the second expected completion time.

### FIELD OF DISCLOSURE

The claimed subject matter relates generally to efficient use of computing resources and, more specifically, to techniques for the scheduling of an Identity Manager reconciliation at an optimal time.

### BACKGROUND OF THE INVENTION

Reconciliation is the process of synchronizing accounts between a managed resource and an Identity Manager (IM). To determine an ownership relationship, reconciliation compares account information with existing user data stored on an IM by first looking for the existing ownership within the IM and, then applying adoption rules configured for the reconciliation. If there is existing ownership for the account on the IM, ownership is not affected by the reconciliation. If ownership does not already exist and there is a match of a user to an account as defined by the adoption rule, the IM creates the ownership relationship between the account and the user. If there is not a match, the IM lists the unmatched accounts as orphaned accounts.

Examples of reconciliation tasks for managed resources may include, but are not limited to:
1) Load access information into an IM directory;
2) Submit reconciliation requests for all resources whose security is managed by the IM;
3) Inserts user access information (accounts) from the local resources into the 1M directory;
4) Monitor accesses granted outside of the IM; and
5) During reconciliation, insert records of all accesses granted outside of the IM into the IM directory. Produce reports of the accounts that have been added or changed on the managed resource since the last reconciliation was performed.

### SUMMARY

Provided are techniques for the scheduling of an Identity Manager reconciliation at an optimal time. The techniques include partitioning a security identity management handling task into a first sub-task and a second sub-task; assigning to the first sub-task a first priority, based upon a first projected number of accounts affected by the first sub-task, a first attribute criteria, a first expected completion time, and a corresponding first scheduler index value, based upon the first priority; and assigning to the second sub-task a second priority, based upon a second projected number of accounts affected by the second sub-task, a second attribute criteria, a second expected completion time, and a second scheduler index value, based upon the second priority; and scheduling the first sub-task prior to the second sub-task in accordance with a prioritization algorithm in which a first weighted combination of the first priority and first expected completion time is greater than a second weighted combination of the second priority and the second expected completion time.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures, in which:

FIG. 1 is a block diagram of a computing system architecture that may support the claimed subject matter.

FIG. 2 is a block diagram showing various aspects of a reconciliation performed in accordance with the claimed subject matter.

FIG. 3 is a block diagram of an Identity Manager (IM) that implements aspects of the claimed subject matter.

FIG. 4 is a flowchart of an Optimize Reconciliation (Recon.) process that may implement aspects of the claimed subject matter.

FIG. 5 is a flowchart of one example of a Reconciliation (Recon.) process conducted in accordance with the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may he any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wired, optical fiber cable, RF, etc., or any suitable combination of the foregoing.

Computer program code for carrying out operations for aspects of the present invention may be written in any combination of one or more programming languages, including an object oriented, programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may he connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks.

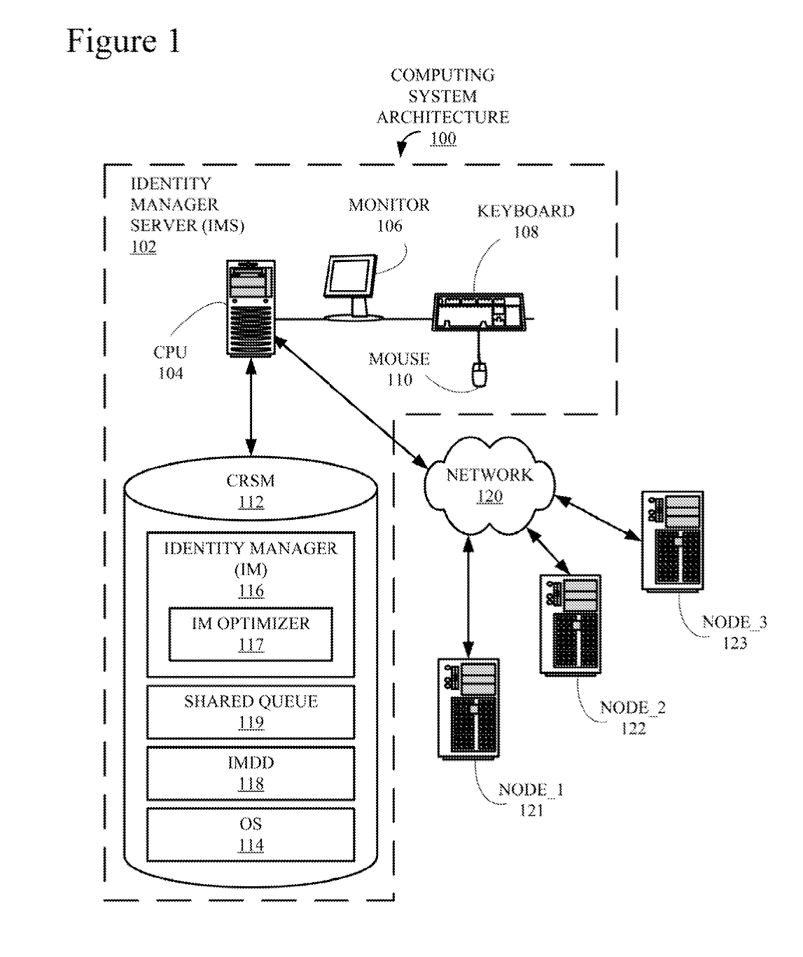

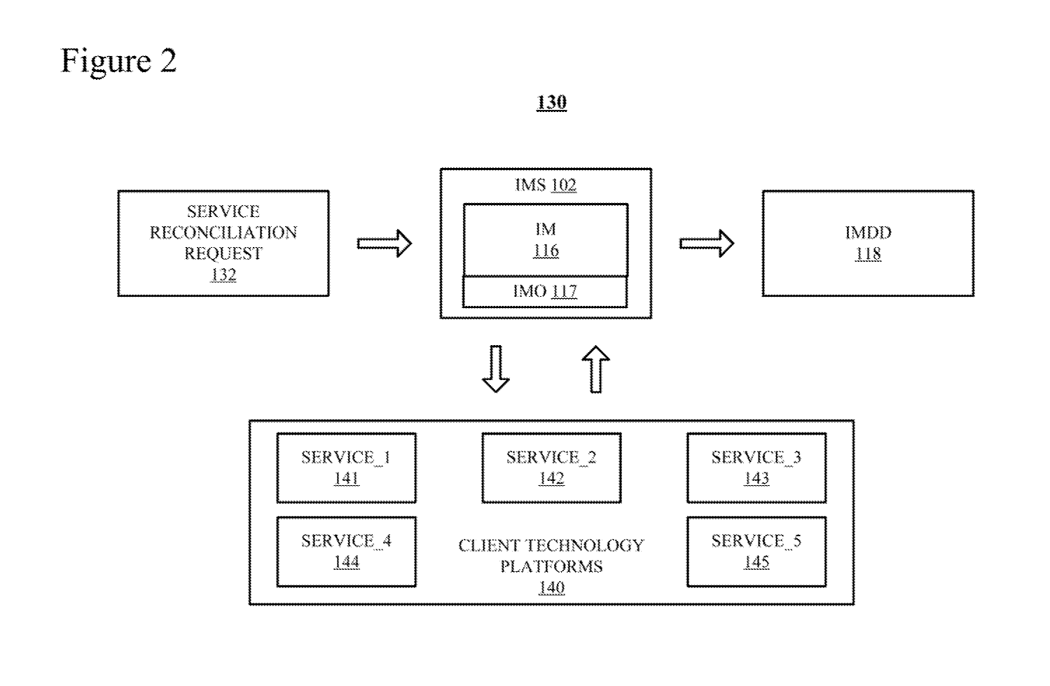

Turning now to the figures, FIG. 1 is a block diagram of an exemplary computing system architecture 100 that incorporates the claimed subject matter. An Identity Manager Server (IMS) 102 includes a central processing unit (CPU) 104, coupled to a monitor 106, a keyboard 108 and a pointing device, or “mouse,” 110, which together facilitate human interaction with computing system 100 and IMS 102. Also included with IMS 102 and attached to CPU 104 is a computer-readable storage medium (CRSM) 112, which may either be incorporated into IMS 102 i.e. an internal device, or attached externally to CPU 104 by means of various, commonly available connection devices such as but not limited to, a universal serial bus (USB) port (not shown). CRSM 112 is illustrated storing logic associated with an operating system (OS) 114, an Identity Manager (IM) 116, which includes an 1114 Optimizer (IMO) 117, an Data Directory (IM DD) 118, and a shared queue 119. Functionality associated with elements 116-119 is described in more detail below in conjunction with FIGS. 2-5. It should be noted that, although illustrated as an entity within IM 116, functionality associated with IMO 117 may be performed by several different elements of IM 116, as explained in more detail below in conjunction with FIGS. 2-5.

IMS 102 is coupled to a network 120, which in turn is coupled to several other computing devices, or nodes, i.e., a node_1 121, a node_2 122 and a node_3 123. Network 120 is not necessarily any particular type of communication medium but may be any number of communication mediums such as, but not limited to, a local area network a wide area network (WAN) the internet, direct wire, a WiFi network and so on. Nodes 121-123 are used in the following description as examples of computing systems that may provide processing, associated with the execution of reconciliations. In the following example, nodes 121-123 perform reconciliations scheduled by IM 116 in conjunction with IMO 117 in accordance with the claimed subject matter. It should be noted there are many possible computing system configurations, of which computing architecture 100, IMS 102 and IM 116 are only simple examples.

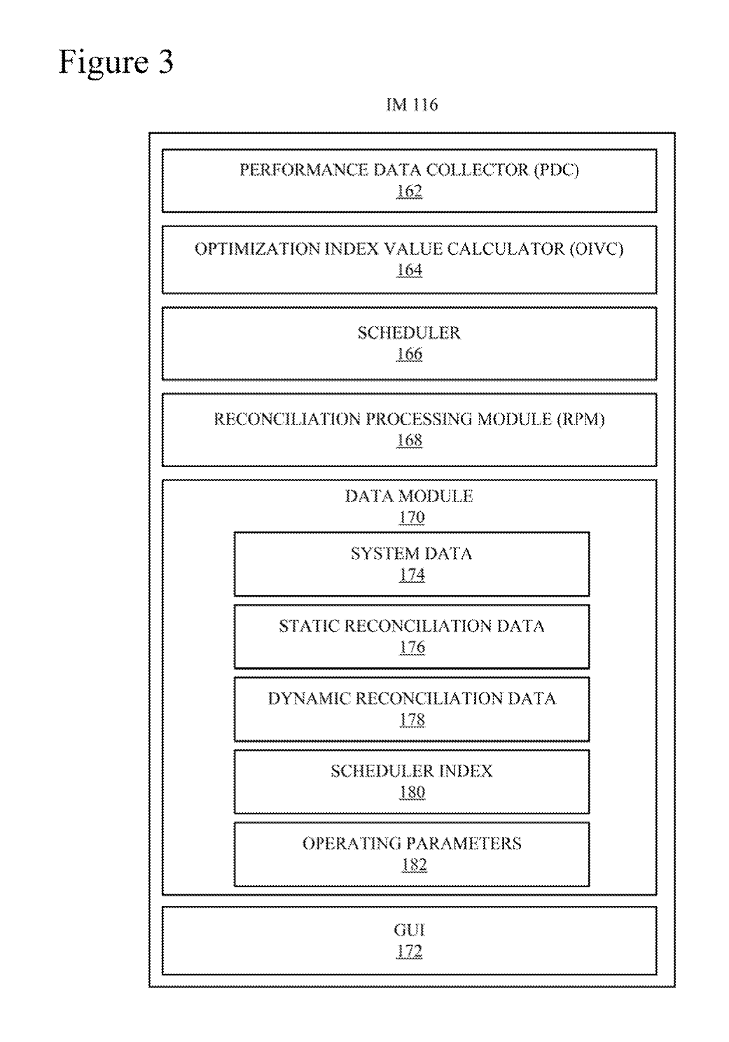

FIG. 2 is a block diagram showing various aspects of a reconciliation 130 performed in accordance with the claimed subject matter. A service reconciliation request, or “task,” 132 is received at EMS 102 (FIG. 1) for processing by IM 116 in conjunction with IMO 117. IM 116 requests and receives information from client technology platforms 140, which are computing devices (not shown) that host a collection of services, e.g., a service_1 141, a service_2 142, a service_3 143, a service_4 144 and a service_5 145. Examples of such services include, but are not limited to, LDAP, DB2, ITIM, and application servers in a clustered environment. Information received by IM 116 and IMO 117 is processed and the results are stored in IM DD 118 (FIG. 1). It should be noted that FIG. 2 is provided merely to introduce various elements of the claimed subject matter and that the actual processing involved in explained in more detail below in conjunction with FIGS. 3-5.

FIG. 3 is a block diagram of IM 116, introduced above in FIG. 1, in greater detail. IM 116 includes a Performance Data Collector (PDC) 162, a Optimization Index Value Calculator (OIVC) 164, a scheduler 166, a reconciliation processing module (RPM) 168, a data, module 170 and a graphical user interface (GUI) 172. It should be understood that the claimed subject matter can be implemented in many types of computing systems and data storage structures but, for the sake of simplicity, is described only in terms of IMS 102 and system architecture 100 (FIG. 1). Further, the representation of IM 116 in FIG. 3 is a logical model. In other words, components 162, 164, 166, 168, 170 and 172 may be stored in the same or separates files and loaded and/or executed within system 100 either as a single system or as separate processes interacting via any available inter process communication (IPC) techniques.

PDC 162 is responsible for the collection of performance data from server machines 140 (FIG. 2) and associated services such as services 141-145 (FIG. 2) by using native IM agents (not shown) or using existing products such as, but not limited to, TIVOLI®. OIVC 164 is responsible for the generation of an index value for each reconciliation request, or task, such as service reconciliation request 132 (FIG. 2) submitted to IT 116.

Scheduler 166 is responsible for the scheduling. of reconciliation tasks such as task 132 in accordance with the claimed subject matter. Reconciliation processing module (RPM) 168 is logic for performing reconciliations. It should be understood that, although IM 116 may perform reconciliations, other nodes such as nodes 121-123 (FIG. 1) also typically do as well. IM 116 and IMO 117 are responsible for operating scheduler 166 and maintaining a “shared queue” from which nodes 121-123 may he assigned reconciliation tasks. In contrast, a typical IM and associated nodes each typically maintain their own schedulers and queues. In this manner, an administrator can ensure that reconciliations are evenly distributed across nodes specifically chosen for the work.

Data module 170 is a data repository for information, including settings and parameters plus historical and current information on platforms 140 (FIG. 2) and services 141-145 (FIG. 2), that IM 116 requires during normal operation. Examples of the types of information stored in data module 170 include system data 174, static reconciliation data 176, dynamic reconciliation data 178, scheduler index 180 and operating parameters 182.

System data 174 includes information concerning the components and protocols of computing system 100, including, but not limited to, data on the number and addressing information of components such as network 120 (FIG. 1) and nodes 121-123 (FIG. 1). Static reconciliation data 176 includes information such as, but not limited to, the available memory, processor speeds, disk types e.g., RAID or non-RAID), and disk speeds for each of nodes 121-123. Dynamic reconciliation data 178 includes, but is not limited to, information on reconciliation types, reconciliation priorities, reconciliation targets (or endpoints), reconciliation start and end times, a number of accounts affected and attributes associated with each account.

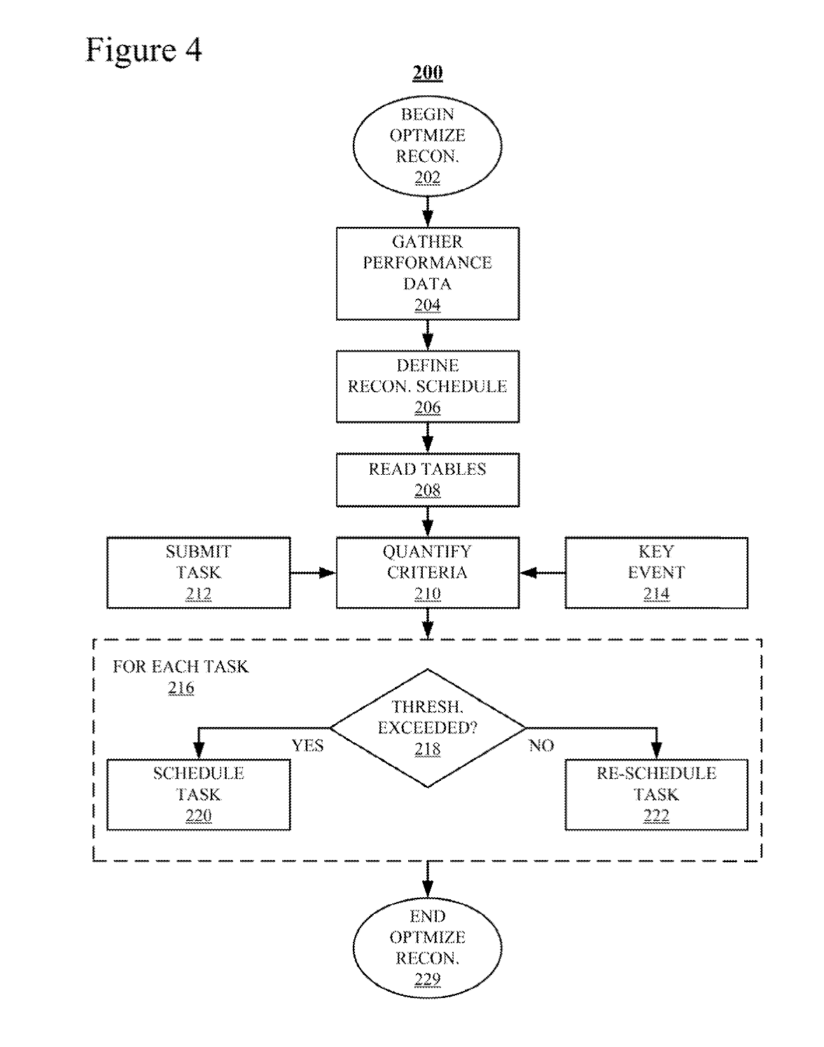

Scheduler index 180 is information for each submitted task, based upon both, the static and dynamic reconciliation data 176 and 178, that is a assigned priority, or “threshold,” value (see 214, FIG. 4) indicating the relative importance of the corresponding task. Each particular task is scheduled (see 216, FIG. 4) based upon the corresponding threshold value in scheduler index 180. Operating parameters data 182 includes information on administrative preferences that have been set. For example, an administrator may specify a specific maximum number of threads that should be made available for a particular task depending upon performance, available resources, a specific threshold value, a manner in which thresholds are calculated and other factors.

GUI component 148 enables administrators of IM 116 to interact with and to define the functionality of IM 116, primarily by setting variables in operating parameters 182.

FIG. 4 is a flowchart of an Optimize Reconciliation (Recon.) process 200 that may implement aspects of the claimed subject matter. In this example, process 200 is associated with logic stored on CRSM 112 (FIG. 1) in conjunction with Identity Manager (IM) 116 (FIGS. 1 and 2) and IMO 117 (FIG. 1) and executed on one or more processors (not shown) of CPU 104 of Identity Manager Server (IMS) 102.

Process 200 starts in a “Begin Optimize Reconciliation (Recon.)” block 202 and proceeds immediately to a “Gather Performance Data” block 204. During processing associated with block 204, performance data is collected from each of the nodes, such as IMS 102 and nodes 121-123 (TAG. 1). Performance data may include, but is not limited to, the available memory, processor speeds, disk types (e.g., RAID or non-RAID), and disk speeds for each of nodes 102 and 121-123 (see 176, FIG. 3).

During processing associated with a “Define Recon. Schedule” block 206, various parameters (see 182, FIG. 3) and data that controls the reconciliation scheduling process are defined. During processing associated with a “Read Tables” block 208, information is retrieved, including, but not limited to, reconciliation types, reconciliation priorities, reconciliation targets (or endpoints), reconciliation start and end times, a number of accounts affected and attributes associated with each account.

During processing associated with a “Quantify Criteria” block 210, information gathered during processing associated with block 204, defined during processing associated with block 206 and retrieved during processing associated with block 208 is processed to assign priorities and threshold values associated with each reconciliation task. During processing associated with a “Submit Task” block 212, a reconciliation task has been submitted and process 200 is entered at block 210 and proceeds as described above and below. In a similar fashion, during processing associated with a “Key Event” block 214, process 200 may also be entered. Key events include, but are not limited to, a successful reconciliation, completion of reconciliation, and a significant change in the availability of resources and/or nodes. In other words, blocks 204, 206 and 208 are not necessarily performed each time a task is submitted but may be scheduled by administrators.

During processing associated with a “For Each Task” block 216, each task is evaluated as described below. During processing associated with a “Threshold (Thresh.) Exceeded?” block 218, a determination is made as to whether or not the current task being processed has a threshold value that exceeds a predefined threshold value. If so, processing proceeds to a “Schedule Task” block 220. During processing associated with block 220, the current task is scheduled for immediate reconciliation. If not, processing proceeds to a “Re-schedule Task” block 222. During processing associated with block 222, the current task is rescheduled tor, typically, an off-peak time or when more resources are available. In this manner, important reconciliation task can be given priority. Finally, once all tasks have been processed during processing associated with block 216, process 200 proceeds to an “End Optimize Recon.” block 229 in which process 200 is complete.

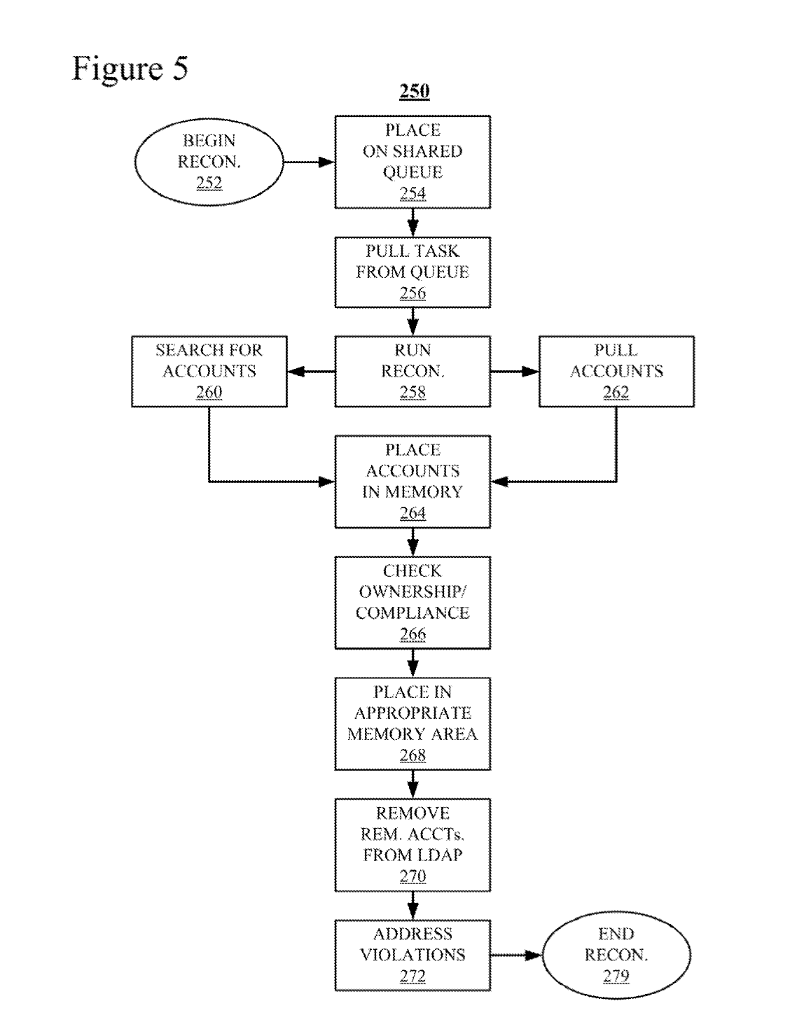

FIG. 5 is a flowchart of one example of a Reconciliation (Recoil.) process 250 conducted in accordance with the claimed subject matter. In this example, process 250 is associated with logic stored on CRSM 112 (FIG. 1) in conjunction with Identity Manager (IM) 116 (FIGS. 1 and 2) and executed on one or more processors (not shown) of CPU 104 of Identity Manager Server (IMS) 102. It should be noted that the process 250 may also be performed on any node, such as nodes 121-123 (FIG. 1) that have been designated by an administrator for that purpose. Scheduled reconciliations represented by process 250 are initiated by scheduler 146 (FIG. 2) in accordance with the prioritization optimization executed by process 200 (FIG. 4).

Process 250 starts in a “Begin Reconciliation (Recon.)” block 252 and proceeds immediately to a “Place on Shared Queue” block 254. During processing associated with block 254, a new task (see 212, FIG. 4) is place on shared queue 119 (FIG. 1) for reconciliation by IM 116. Tasks placed upon shared queue 119 may be processed by any nodes, which in this example are nodes 121-123, that have been designated as available for reconciliations. Dining processing associated with a “Pull task From Queue” block 256, a task is pulled from shared queue 119 for processing, by one of the nodes 121-123. It should be noted that the task pulled from the queue during processing associated with block 256 may not be the same task placed on the queue during processing associated with block 254 and that the remaining blocks are performed by the particular node 121-123 that pulled the task.

During processing associated with as “Run Reconciliation (Recon.)” block 258, the node 121-123 that pulled a task, form shared queue 119 begins the reconciliation on the task. After the particular node's scheduler (not shown) picks up a scheduled reconciliation it creates a start -the-recon MIS message on a itim_rs queue (not shown). The itim_rs queue is a local queue to the particular node and is not shared with any of the nodes in a cluster. At this point, the reconciliation has not been recorded in an audit trail (not shown) When the start-the-recon message is received, a workflow engine (rim shown) is notified to start the reconciliation workflow, which creates a pending process in the workflow audit trail. When the workflow engine executes the main reconciliation activity, another JMS message to run the reconciliation is placed on the itim_rs queue. The two messages on itim_rs may be used to when examining the timing of reconciliation processes appearing in the audit trail (see 178, FIG. 3). Once a run-the-recon message is pulled from itim_rs, an IM associated with the particular node 121-123 enters a three-phase process.

In a Phase 1 the IM initiates a search for the accounts on the endpoint during processing associated with a “Search for Accounts” block 260 while concurrently starting an IM LDAP search to pulling out the corresponding; accounts, if any, during processing associated with a “Pull Accounts” block 262. if the endpoint search during processing associated with block 260 finishes before the IM LDAP search does during processing associated with block 262, the endpoint search is blocked from returning results until the IM LDAP search finishes.

Phase 2 begins after IM finishes pulling back all the accounts from the IM LDAP during processing associated with block 262. In this phase, during processing associated with a “Place Accounts in Memory” block 264, the accounts are read from an adapter on a message thread and placed onto an in-memory, fixed size queue associated with the particular node 121-123. During processing associated with block 264, the accounts located during processing associated with block 260 and pulled during processing associated with block 262 are placed in memory. It should be noted that, while reading in the results from the IM LDAP if more than a specified number are found, based upon an account cache size threshold, only the erGlobalID and eruid for the remainder of the accounts are stored instead of the entire account object to minimize memory footprint.

As they are pulled off the queue by worker threads, they are compared against the account found in the in-memory list during, processing associated with a “Check Ownership/Compliance” block 266. If only the erGlobalID and eruid were stored due to the account cache size threshold, the full account object is looked up prior to comparing it to the record pulled from the adapter. If necessary, adoption scripts are executed to find the account's owner. During processing associated with a “Place in Appropriate Memory Area” block 268. if after the adoption script is run it's still an orphaned account, it's added/updated in the IM LDAP. If it's an owned account and policy checking for the reconciliation is disabled, or if policy checking is enabled and it's compliant, then the account is added/updated to the IM LDAP. If it's an owned non-compliant account, and policy checking is enabled, then the account is added to one of two in-memory lists (non-compliant and disallowed accounts). These will be handled in Phase 3.

When all results are pulled from the adapter, any accounts left in the in-memory list from the IM LDAP are removed from LDAP during processing associated with a “Remove Remainder (Rem.) Accounts (Acts.) from LDAP” block 270. Also, for any newly compliant accounts of deleted accounts where IM has a record of compliance issues in the IM LDAP, those accounts are added to a third in-memory list for action in Phase 3. At the end of Phase 2, worker threads are terminated, and the messaging thread is returned to the pool. The reconciliation workflow continues in Phase 3.

In Phase 3, during processing associated with an “Address Violations” block 272, policy violations are acted upon. For non-compliant and disallowed accounts, the actions depend on the policy enforcement setting for the service. Also, any stale compliance issues located during Phase 2 are removed. Each of the three lists is implemented as an IM workflow loop that takes the necessary actions on each list entry. In a default IM environment it is possible for a node to have over 45 threads (5*9) working on reconciliation at one time if 5 or more reconciliations are running concurrently. The CPU required to run a reconciliation depends on if the account value has changed and if it was changed if it is compliant or not. Unchanged accounts have the least overhead, followed by changed but compliant accounts. Changed and non-compliant accounts have the most overhead. Finally, during processing associated with an “End Reconciliation” block 279, process 250 is complete.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended, to include any structure, material, or act for performing the function in combination with other claimed elements as specifically claimed. The description of the present invention has been presented for purposes of illustration and description, but is not intended to he exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur Out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method, comprising:
partitioning a security identity management handling task into a first sub-task and a second sub-task;
assigning to the first sub-task a first priority, based upon a first projected number of accounts affected by the first sub-task, a first attribute criteria, a first expected completion time, and a corresponding first scheduler index value, based upon the first priority; and
assigning to the second sub-task a second priority, based upon a second projected number of accounts affected by the second sub-task, a second attribute criteria, a second expected completion time, and a second scheduler index value, based upon the second priority; and
scheduling the first sub-task prior to the second sub-task in accordance with a prioritization algorithm in which a first weighted combination of the first priority and first expected completion time is greater than a second weighted combination of the second priority and the second expected completion time.

2. The method of claim 1, wherein the first and second sub-tasks are from a plurality of three or more sub-tasks and, wherein each sub-task of the plurality of three or more subtasks is scheduled with respect to each other of the three or more sub-tasks in accordance with the scheduling of the first and second sub-tasks.

3. The method of claim 1, wherein the prioritization algorithm is based upon a predicted availability of a resource.

4. The method of claim 1, wherein the predicted availability of the resource is based upon a determination of peak and off-peak times correspond rug to the resource.

5. The method of claim 3, further comprising:
assigning to the first sub-task a first threshold value, the first threshold value based upon a minimum time for a reconciliation task corresponding to the first sub-task to be initiated;
determining whether or not the threshold value exceeds a minimum threshold value; and
in response to a determining that the threshold value exceeds the minimum threshold value, scheduling the first sub-task fur immediate execution; and
otherwise, postponing scheduling of the first sub-task for execution at an off-peak time of the resource.

6. The method of claim 3, further comprising:
collecting static reconciliation data comprising information from the resource from a list, consisting of:
available memory;
processor speed;
disk types; and
disk speeds; and
generating the predicted availability of a resource based upon the static reconciliation data.

7. The method of claim further comprising;
collecting dynamic reconciliation data comprising information from a list, consisting of:
reconciliation types;
reconciliation priorities;
reconciliation targets;
reconciliation start times;
reconciliation end times,
a number of accounts affected; and
attributes associated with each account affected; and
basing the scheduling on the dynamic reconciliation data.

8. An apparatus, comprising:
a plurality of processors;
a non-transitory computer-readable storage medium coupled to the plurality of processors; and
logic, stored on the computer-readable storage medium and executed on the processor, for:
partitioning a security identity management handling task into a first sub-task and a second sub-task;
assigning to the first sub-task a first priority, based upon a first projected number of accounts affected by the first sub-task, a first attribute criteria, a first expected completion time, and a corresponding first scheduler index value, based upon the first priority; and
assigning to the second sub-task a second priority, based upon a second projected number of accounts affected by the second sub-task, a second attribute criteria, a second expected completion time, and a second scheduler index value, based upon the second priority; and
scheduling the first sub-task prior to the second sub-task in accordance with a prioritization algorithm in which a first weighted combination of the first priority and first expected completion time is greater than a second weighted combination of the second priority and the second expected completion time.

9. The apparatus of claim 8, wherein the first and second sub-tasks are from a plurality of three or more sub-tasks and, wherein each sub-task of the plurality of three or more subtasks is scheduled with respect to each other of the three or more sub-tasks in accordance with the scheduling of the first and second sub-tasks.

10. The apparatus of claim 8, wherein the prioritization algorithm is based upon a predicted availability of a resource.

11. The apparatus of claim 10, wherein the predicted availability of the resource is based upon a determination of peak and off-peak times corresponding to the resource.

12. The apparatus of claim 10, the logic further comprising logic for:
assigning to the first sub-task a first threshold value, the first threshold value based upon a minimum time for a reconciliation task corresponding to the first sub-task to be initiated;
determining whether or not the threshold value exceeds a minimum threshold value; and
in response to a determining that the threshold value exceeds the minimum threshold value, scheduling the first sub-task for immediate execution; and
otherwise, postponing scheduling of the first sub-task for execution at an off-peak time of the resource.

13. The apparatus of claim 10, the logic further comprising logic for:
collecting static reconciliation data comprising information from the resource from a list, consisting of:
available memory;
processor speed;
disk types; and
disk speeds; and
generating the predicted availability of a resource based upon the static reconciliation data.

14. The apparatus of claim 8 further comprising:
collecting dynamic reconciliation data comprising information from a list, consisting of:
reconciliation types;
reconciliation priorities;
reconciliation targets;
reconciliation start times;
reconciliation end times,
a number of accounts affected; and
attributes associated with each account affected; and
basing the scheduling on the dynamic reconciliation data.

15. A computer programming product for providing security identity management handling, the computer programming product comprising a non-transitory computer-readable storage medium having program code embodied therewith, the program code executable by a plurality of processors to perform a method comprising:
partitioning, by the plurality of processors, a security identity management handling task into a first sub-task and a second sub-task;
assigning, by the plurality of processors, to the first sub-task a first priority, based upon a first projected number of accounts affected by the first sub-task, a first attribute criteria, a first expected completion time, and a corresponding first scheduler index value, based upon the first priority; and
assigning, by the plurality of processors, to the second sub-task a second priority, based upon a second projected number of accounts affected by the second sub-task, a second attribute criteria, a second expected completion time, and a second scheduler index value, based upon the second priority; and
scheduling, by the plurality of processors, the first sub-task prior to the second sub-task in accordance with a prioritization algorithm in which a first weighted combination of the first priority and first expected completion time is greater than a second weighted combination of the second priority and the second expected completion time.

16. The computer programming product of claim 15, wherein the first and second sub-tasks are from a plurality of three or more sub-tasks and, wherein each sub-task of the plurality of three or more subtasks is scheduled with respect to each other of the three or more sub-tasks in accordance with the scheduling of the first and second sub-tasks.

17. The computer programming product of claim 15, wherein the prioritization algorithm is based upon a predicted availability of a resource.

18. The computer programming of claim 17, the method further comprising;
assigning to the first sub-task a first threshold value, the first threshold. value based upon a minimum time for a reconciliation task corresponding to the first sub-task to be initiated;
determining whether or not the threshold value exceeds a minimum threshold value; and
in response to a determining that the threshold value exceeds the minimum threshold value, scheduling the first sub-task for immediate execution; and
otherwise, postponing scheduling of the first sub-task for execution at an off-peak time of the resource.

19. The computer programming product of claim 17, the method further comprising:
collecting static reconciliation data comprising information from the resource from a list, consisting of:
available memory;
processor speed;
disk types; and
disk speeds; and
generating the predicted availability of a resource based upon the static reconciliation data.

20. The computer programming product of claim 15 the method further comprising:
collecting dynamic reconciliation data comprising information from a list, consisting of:
reconciliation types;
reconciliation priorities;
reconciliation targets;
reconciliation start times;
reconciliation end times,
a number of accounts affected; and
attributes associated with each account affected; and
basing the scheduling on the dynamic reconciliation data.
